(19) United States
(12) Patent Application Publication
(10) Pub. No.: US 2015/0134933 A1
(43) Pub. Date: May 14, 2015

(54) ADAPTIVE PREFETCHING IN A DATA PROCESSING APPARATUS

(71) Applicant: ARM Limited, Cambridge (GB)

(72) Inventors: Rune HOLM, Cambridge (NO); Ganesh Suryanarayan Dasika, Austin, TX (US)

(73) Assignee: ARM Limited, Cambridge (GB)

(21) Appl. No.: 14/080,139

(22) Filed: Nov. 14, 2013

(51) Int. Cl. G06F 9/38

(52) U.S. Cl. CPC G06F 9/3808
USPC 712/207

(57) ABSTRACT

A data processing apparatus and method of data processing are disclosed. An instruction execution unit executes a sequence of program instructions, wherein execution of at least some of the program instructions initiates memory access requests to retrieve data values from a memory. A prefetch unit prefetches data values from the memory for storage in a cache unit before they are requested by the instruction execution unit. The prefetch unit is configured to perform a miss response comprising increasing a number of the future data values which it prefetches, when a memory access request specifies a pending data value which is already subject to prefetching but is not yet stored in the cache unit. The prefetch unit is also configured, in response to an inhibition condition being met, to temporarily inhibit the miss response for an inhibition period.

### FIELD OF THE INVENTION

The present invention relates to data processing apparatuses. More particularly, the present invention relates to the prefetching of data values in a data processing apparatus.

### BACKGROUND OF THE INVENTION

It is known for a data processing apparatus which executes a sequence of program instructions to be provided with a prefetcher which seeks to retrieve data values from memory for storage in a cache local to an instruction execution unit of the data processing apparatus in advance of those data values being required by the instruction execution unit. The memory latency associated with the retrieval of data values from memory in such data processing apparatuses can be significant, and without such prefetching capability being provided would present a serious performance impediment for the operation of the data processing apparatus.

It is further known for such a prefetcher to dynamically adapt the number of data values which it prefetches into the cache in advance. On the one hand, if the prefetcher does not prefetch sufficiently far in advance of the activities of the processor (instruction execution unit), the processor will cache up with the prefetcher and will seek access to data values in the cache before they have been retrieved from the memory, requiring the processor to wait whilst the corresponding memory accesses complete. On the other hand, if the prefetcher prefetches data values too far in advance, data values will be stored in the cache for a long time before they are required and risk being evicted from the cache by other memory access requests in the interim. The desirable balance between these competing constraints can vary in dependence on the nature of the data processing being carried out and accordingly it is known for the prefetcher to be configured to adapt its prefetch distance (i.e. how far is advance of the processor it operates) dynamically i.e. in the course of operation by data processing apparatus.

### SUMMARY OF THE INVENTION

Viewed from a first aspect, the present invention provides a data processing apparatus comprising:

an instruction execution unit configured to execute a sequence of program instructions, wherein execution of at least some of the program instructions initiate memory access requests to retrieve data values from a memory;

a cache unit configured to store copies of the data values retrieved from the memory; and

a prefetch unit configured to prefetch the data values from the memory for storage in the cache unit before they are requested by the instruction execution unit by extrapolating a current data value access pattern of the memory access requests to predict future data values which will be requested by the instruction execution unit and prefetching the future data values,

wherein the prefetch unit is configured to perform a miss response comprising increasing a number of the future data values which it prefetches when a memory access request specifies a pending data value which is already subject to prefetching but is not yet stored in the cache unit,

wherein the prefetch unit is configured, in response to an inhibition condition being met, to temporarily inhibit the miss response for an inhibition period.

The prefetch unit according to the present techniques is configured to dynamically adjust its prefetch distance, i.e. the number of future data values for which it initiates a prefetch before those data values are actually requested by memory accesses issued by the instruction execution unit. It should be understood that here the term “data value” should be interpreted as generically covering both instructions and data. This dynamic adjustment is achieved by monitoring the memory access requests received from the instruction execution unit and determining whether they are successfully anticipated by data values which have already been prefetched and stored in the cache unit. In particular, the prefetch unit is configured to adapt the prefetch distance by performing a miss response in which the number of data values which it prefetches is increased when a received memory access request specifies a data value which is already the subject of prefetching, but has not yet been stored in the cache unit. In other words, generally the interpretation in this situation is that the prefetcher has correctly predicted that this data value will be required by a memory access request initiated by the instruction execution unit, but has not initiated the prefetching of this data value sufficiently far in advance for it already to be available in the cache unit by the time that memory access request is received from the instruction execution unit. Accordingly, according to this interpretation, the prefetch unit can act to reduce the likelihood of this occurring in the future by increasing the number of data values which it prefetches, i.e. increasing its prefetch distance, such that the prefetching of a given data value which is predicted to be required by the instruction execution unit is initiated further in advance of its actually being required by the instruction execution unit.

However, the present techniques recognise that it may not always be desirable for the prefetch unit to increase its prefetch distance every time a memory access request is received from the instruction execution unit which specifies a data value which is already subject to prefetching but is not yet stored in the cache. For example, the present techniques recognise that in the course of the data processing activities carried out by the data processing apparatus, situations can occur where increasing the prefetch distance would not necessarily bring about an improvement in data processing performance and may therefore in fact be undesirable. Accordingly, the present techniques provide that the prefetch unit can additionally monitor for an inhibition condition and where this inhibition condition is satisfied, the prefetch unit is configured to temporarily inhibit the usual miss response (i.e. increasing the prefetch distance) for a predetermined inhibition period. This then enables the prefetch unit to identify those situations in which the performance of the data processing apparatus would not be improved by increasing the prefetch distance and to temporarily prevent that usual response.

The inhibition condition may be configured in a number of different ways, but in one embodiment the inhibition condition comprises identification of a mandatory miss condition, wherein the mandatory miss condition is met when it is inevitable that the pending data value specified by the memory access request is not yet stored in the cache unit. Accordingly, in situations where it is inevitable that the pending data value is not yet stored in a cache unit, i.e. the fact that the data value is not yet stored in cache unit could not have been avoided by a different configuration of the prefetch unit, it is then advantageous for the configuration of the prefetch in unit is particular its prefetch distance) not to be altered.

A mandatory miss condition may arise for a number of reasons, but in one embodiment the mandatory miss condition is met when the memory access request is not prefetchable. The fact that the memory access request is not prefetchable thus presents one reason explains why the configuration of the prefetch unit (in particular its prefetch distance) was not at fault, i.e. did not cause the pending data value to not yet be stored in the cache unit.

In some embodiments the prefetch unit is configured to perform a stride check for each memory access request, wherein the stride check determines if the memory access request does extrapolate the current data value access pattern, and wherein memory addresses in the data processing apparatus are administered in memory pages, and wherein the prefetch unit is configured to suppress the stride check in response to a set of memory addresses corresponding to the number of the future data values crossing a page boundary. In order to successfully extrapolate the current data value access pattern of the memory access requests being issued by the instruction execution unit, the prefetch unit may generally be configured to check for each new memory access request if the corresponding new address does match the predicted stride (i.e. data value access pattern extrapolation), but this stride check can be suppressed when a page boundary is crossed to save unnecessary processing where there is a reasonable expectation that the stride check may in any regard not result in a match.

In some embodiments, memory addresses in the data processing apparatus are administered in memory pages and the inhibition condition is met when a set of memory addresses corresponding to the number of the future data values crosses a page boundary. When the number of future data values being prefetched by the prefetch unit crosses a page boundary, this means that a first subset of those data values are in one memory page, whilst a second part of those data values are in a second memory page. Due to the fact that the physical addresses of one memory page may have no correlation with the physical addresses of a second memory page, this presents a situation in which it may well not have been possible for the prefetch unit to have successfully predicted and prefetched the corresponding target data value.

In some embodiments, the prefetch unit is configured such that the inhibition condition is met for a predetermined period after the number of the future data values (i.e. the prefetch distance) has been increased. It has been recognised that, due to the memory access latency, when the prefetch distance is increased the number of memory access requests which are subject to prefetching (and corresponding to a particular program instruction) will then increase before a corresponding change in the content of the cache unit has resulted and there is thus an interim period in which it is advantageous for the miss response (i.e. further increasing the prefetch distance) to be inhibited. Indeed, positive feedback scenarios can be envisaged in which the prefetch distance could be repeatedly increased. Whilst this is generally not a problem in the case of a more simple instruction execution unit, which would be stalled by the first instance in which the pending data value is not yet stored in the cache unit, in the case of a multi-threaded instruction execution unit, say, a greater likelihood exists of such repeated memory access requests relating to data values which are already subject to prefetching but not yet stored in the cache unit and the present mitigate litigate against repeated increased in the prefetch distance occurring as a result.

The duration of the inhibition period can be configured in a variety of ways depending on the particular constraints of the data processing apparatus, but in one embodiment the inhibition period is a multiple of a typical memory latency of the data processing apparatus, the memory latency representing a time taken for a data value to be retrieved from the memory. The inhibition period can therefore be arranged such that an adjustment in the number of future values which the prefetch unit prefetches (i.e. the prefetch distance) cannot be increased until this multiple of the typical memory latency has elapsed. For example, in the situation where the prefetch distance has not been increased because the prefetch distance has only recently been increased, this inhibition period then allows sufficient time for the desired increase in content of the cache unit to result.

The instruction execution unit may take a variety of forms, but in one embodiment, the data processing apparatus comprises plural instruction execution units configured to execute the sequence of program instructions. Further, in some embodiments the instruction execution unit is configured to execute multiple threads in parallel when executing the sequence of program instructions. Indeed, in some such embodiments, the instruction execution unit is configured to operate in a single instruction multiple thread fashion. As mentioned above, some of the problems which the present techniques recognise with respect to increasing the prefetch distance in response to a cache miss in a cache line which is already subject to a prefetch request can become more prevalent in a data processing apparatus which is configured to execute instructions in a more parallel fashion, and multi-core and/or multi-threaded data processing apparatuses represent examples of such a device.

Whilst the prefetch unit may be configured to increase its prefetch distance as described above, it may also be provided with mechanisms for decreasing the prefetch distance, and in one embodiment the prefetch unit is configured to periodically decrease the number of future data values which it prefetches. Accordingly, this provides a counterbalance for the increases in the prefetch distance which can result from the miss response, and as such a dynamic approach can be provided whereby the prefetch distance is periodically decreased and only increased when required. This then allows the system to operate in a configuration which balances the competing constraints of the prefetcher operating sufficiently in advance of the demands of the instruction execution unit whilst also not fetching too far in advance, thus using up more memory bandwidth than is necessary.

In some embodiments the prefetch unit is configured to administer the prefetching of the future data values with respect to a prefetch table, wherein each entry in the prefetch table is indexed by a program counter value indicative of a selected instruction in the sequence of program instructions, and each entry in the prefetch table indicates the current data value access pattern for the selected instruction, and wherein the prefetch unit is configured, in response to the inhibition condition being met, to suppress amendment of at least one entry in the prefetch table. The prefetch unit may maintain various parameters within each entry in the prefetch table to enable it to predict and prefetch data values that will be required by the instruction execution unit, and in response to the inhibition condition, it may be advantageous to leave these parameters unchanged. In other words, the confidence which the prefetch unit has developed in the accuracy of the prefetch table entries need not be changed when the inhibition condition is met.

Viewed from a second aspect the present invention provides a data processing apparatus comprising:

means for executing a sequence of program instructions, wherein execution of at least some of said program instructions initiate memory access requests to retrieve data values from a memory;

means for storing copies of the data values retrieved from the memory; and
means for prefetching the data values from the memory for storage by the means for storing before they are requested by the means for executing by extrapolating a current data value access pattern of the memory access requests to predict future data values which will be requested by the means for executing and prefetching the future data values,
wherein the means for prefetching is configured to perform a miss response comprising increasing a number of the future data values which it prefetches when a memory access request specifies a pending data value which is already subject to prefetching but is not yet stored in the means for storing,
wherein the means for prefetching is configured, in response to an inhibition condition being met, to temporarily inhibit the miss response for an inhibition period.

Viewed from a third aspect the present invention provided a method of data processing comprising the steps of:

executing a sequence of program instructions, wherein execution of at least some of said program instructions initiate memory access requests to retrieve data values from a memory;

storing copies of the data values retrieved from the memory in a cache;

prefetching the data values from the memory for storage in the cache before they are requested by the executing step by extrapolating a current data value access pattern of the memory access requests to predict future data values which will be requested by the executing step and prefetching the future data values;

performing a miss response comprising increasing a number of the future data values which prefetched when a memory access request specifies a pending data value which is already subject to prefetching but is not yet stored in the cache; and

in response to an inhibition condition being met, temporarily inhibiting the miss response for an inhibition period.

### BRIEF DESCRIPTION OF THE DRAWINGS

The present invention will be described further, by way of example only, with reference to embodiments thereof as illustrated in the accompanying drawings, in which:

FIG. 1 schematically illustrates a data processing apparatus in one embodiment in which two multi-threaded processor cores are provided;

FIG. 2 schematically illustrates the development of entries in a prefetch table in response to executed program instructions and the resulting pending prefetches and level two cache content;

FIG. 3 schematically illustrates the correspondence between pages of virtual addresses and pages of physical addresses, and the prefetching problems which may arise on page boundaries;

FIG. 4 schematically illustrates a prefetch unit in one embodiment; and

FIG. 5 schematically illustrates a sequence of steps which may be taken by a prefetch unit in one embodiment.

### DESCRIPTION OF EMBODIMENTS

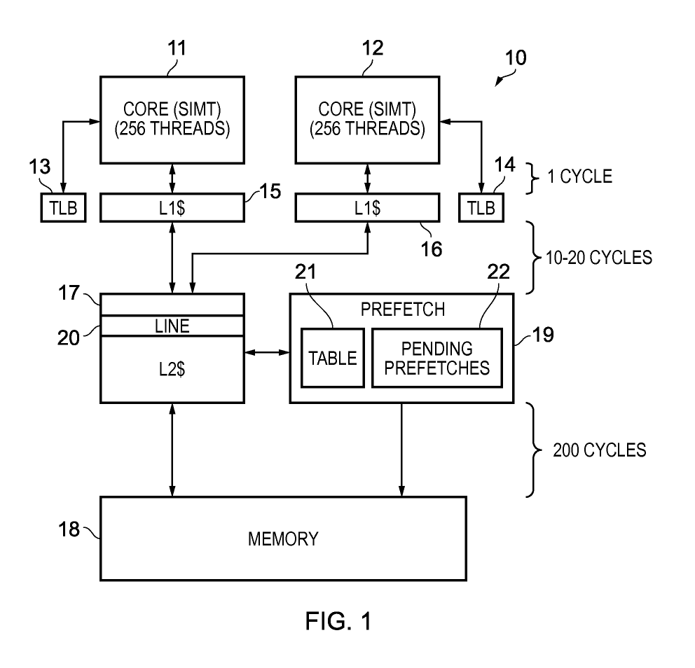

FIG. 1 schematically illustrates a data processing apparatus 10 in one embodiment. This data processing apparatus is a multi-core device, comprising a processor core 11 and a processor core 12. Each processor core 11, 12 is a multi-threaded processor capable of executing up to 256 threads in a single instruction multi-thread (SIMT) fashion. Each processor core 11, 12 has an associated translation look aside buffer (TLB) 13, 14 which each processor core uses as its first point of reference to translate the virtual memory addresses which the processor core uses internally into the physical addresses used by the memory system.

The memory system of the data processing apparatus 10 is arranged in a hierarchical fashion, wherein a level 1 (L1) cache 15, 16 is associated with each processor core 11, 12, whilst the processor cores 11, 12 share a level 2 (L2) cache 17. Beyond the L1 and L2 caches, memory accesses are passed out to external memory 18. There are significant differences in the memory latencies associated with each of the three levels of this memory hierarchy. For example, whilst it only takes approximately one cycle for a memory access request to access the L1 caches 15, 16, it typically takes 10-20 cycles for a memory access request which is passed out to the L2 cache 17, and a memory access request which does not hit in any of the caches and must therefore be passed out to the external memory 18 typically takes of the order of 200 cycles to complete.

Due to the significant memory latency in particular associated with accessing the memory 18, the data processing apparatus 10 is further provided with a prefetch unit 19 associated with the L2 cache 17. This prefetch unit 19 is configured to monitor the memory access requests received by the L2 cache 17 and on the basis of access patterns seen for those memory access requests to generate prefetch transactions which retrieve data values from memory 18 which are expected to be required in the future by one of the cores 11, 12. By causing these data values to be prepopulated in a cache line 20 of the level cache 17, the prefetch unit 19 seeks to hide the large memory latency associated with accessing memory 18 from the processor cores 11, 12.

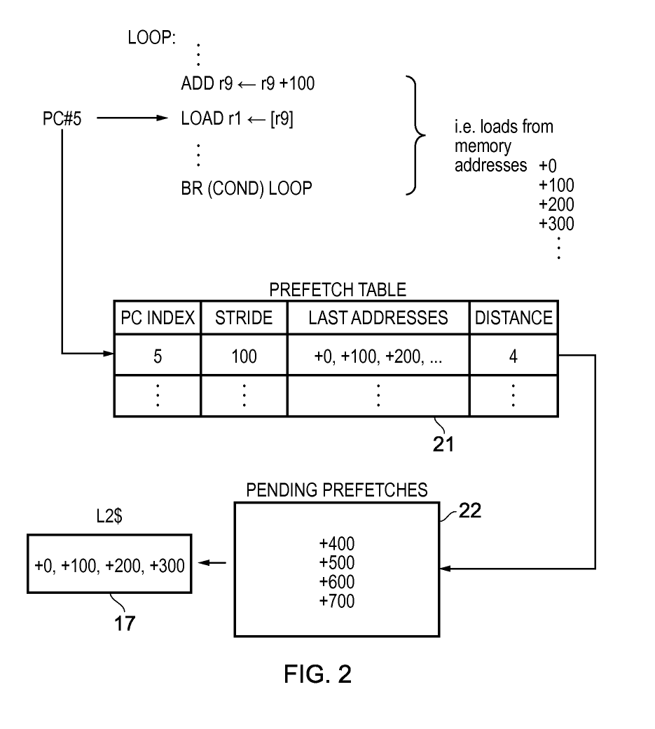

In order to do this, the prefetch unit 19 must in particular maintain a given “prefetch distance” with respect to the memory access requests being issued by the processor cores 11, 12 by issuing a number of prefetch transactions in advance of the corresponding memory access requests being issued by the cores 11, 12, such that these prefetch transactions have time to complete and populate a cache line 20 before the corresponding data value is required and requested by a memory access request issued by one of the processor cores 11, 12. Accordingly, the prefetch unit 19 is provided with a prefetch table 21 populated with entries corresponding to the memory access requests observed to be received by the L2 cache 17 and allowing the prefetch unit 19 to develop a data value access pattern which it can extrapolate to determine the prefetch transactions which should be issued. More detail of this table 21 will be given below with reference to FIG. 2.

The prefetch unit 19 also maintains a list of pending prefetches 22, i.e. a record of the prefetch transactions which it is has issued, but have not yet completed. In other words, as part of monitoring the L2 cache 17, when a prefetch transaction issued by the prefetch unit 19 completes and the corresponding data has been stored in a cache line 20, the corresponding entry in the list of pending prefetches 22 can be deleted. One particular use of the pending prefetches list 22 is to enable the prefetch unit 19 to adapt the prefetch distance it maintains with respect to a given entry in its prefetch table 21. When the prefetch unit 19 observes a memory access request received by the L2 cache 17 which hits in a cache line 20 which is currently in the process of being prefetched (i.e. has a corresponding entry in the pending prefetch list 22) then the prefetch unit 19 generally uses this as a trigger to increase the prefetch distance for that entry in the prefetch table 21, since this may well be an indication that the prefetch unit 19 needs to issue a prefetch transition for this entry in the prefetch table 21 earlier if it is to complete and populate the corresponding cache line 20 before the expected access request from one of the processor cores 11, 12 is received by the L2 cache 17. However, according to the present techniques the prefetch unit 19 will not always increase the prefetch distance in response to this situation, as will be described in more detail with respect to the following figures.

FIG. 2 shows some example program instructions being executed, the resulting entry in the prefetch table 21, the corresponding pending prefetches and corresponding L2 cache content. As can be seen from the example program instructions, this sequence of program instructions comprises a loop which, dependent on the condition COND, could be repeatedly executed many times. The two program instructions of significance to the present techniques are the first ADD instruction which increments the value stored in register r9 by 100 and the following LOAD instruction which causes the data value stored at the memory address given by the current content of register r9 to be loaded into the register r1. Accordingly, it will be understood that (assuming the value held in register r9 is not otherwise amended within this loop) the LOAD instruction will causes memory access requests to be made for memory addresses which increment in steps of 100. The prefetch table 21 is PC indexed and in the figure the LOAD instruction is given the example program counter (PC) value of five. The prefetch unit 19 therefore observes memory access requests associated with this PC value being issued with respect to memory addresses which increment by 100 and one part of the corresponding entry in the prefetch table 21 keeps record of the memory addresses most recently seen in connection with this PC value. On the basis of the pattern of these memory addresses, the prefetch unit 19 thus determines a “stride” of 100 which forms another part of the corresponding entry in the prefetch table 21 and on the basis of which it can extrapolate the access pattern to generate prefetch transactions for the memory access requests seen to be received by the L2 cache 17 in association with this PC value. For each new memory access request seen in association with this PC value, the control prefetch unit 19 is configured to determine if there is a “stride match”, i.e. if the extrapolation of the access pattern using the stride value stored has correctly predicted the memory address of this memory access request. Where the extrapolation does not match, the prefetch unit (in accordance with techniques known in the art) can revise the corresponding entry in the prefetch table 21.

The final part of the entry in the prefetch table 21 is the prefetch distance which the prefetch unit maintains for this entry. This prefetch distance determines how many transactions in advance of the latest memory access request seen in association with this PC value the prefetch unit 19 generates. For example, in the snap shot shown in FIG. 2, the prefetch distance for the entry in the prefetched table 21 corresponding to PC value 5 is currently 4. Accordingly, where the most recent memory access request associated with this PC value has been for the memory address “+300”, there are four pending prefetch transactions in advance of this (i.e. “+400”, “+500”, “+600” and “+700”) as shown by the content of the pending prefetch list 22. Further, the L2 cache 17 already contains entries corresponding to the preceding memory access requests relating to memory addresses “+0”, “+100”, “+200” and “+300”. Accordingly, the current memory access request at memory address “+300” will hit in the L2 cache 17 without needing to be passed further to the external memory 18.

The prefetch unit 19 is configured to dynamically adapt the prefetch distance in order to seek to maintain an optimised balance between not prefetching far enough in advance (and thus causing the processor cores 11, 12 to wait while the prefetched transaction corresponding to a memory access request catches up), and prefetching too far in advance which uses unnecessary memory bandwidth and further risks prefetched entries in the cache 17 being evicted before they have been used by the processor cores 11, 12. As a part of this dynamic adaptation, the prefetch unit 19 is generally configured to determine when a memory access request has been received by the L2 cache 17 which is currently in the process of being prefetched (i.e. has a corresponding entry in the pending prefetch list 22) and in this situation to increase the prefetch distance. However, the prefetch unit 19 is, in accordance with the present techniques, additionally configured to temporarily inhibit this response for a predetermined period under certain identified conditions.

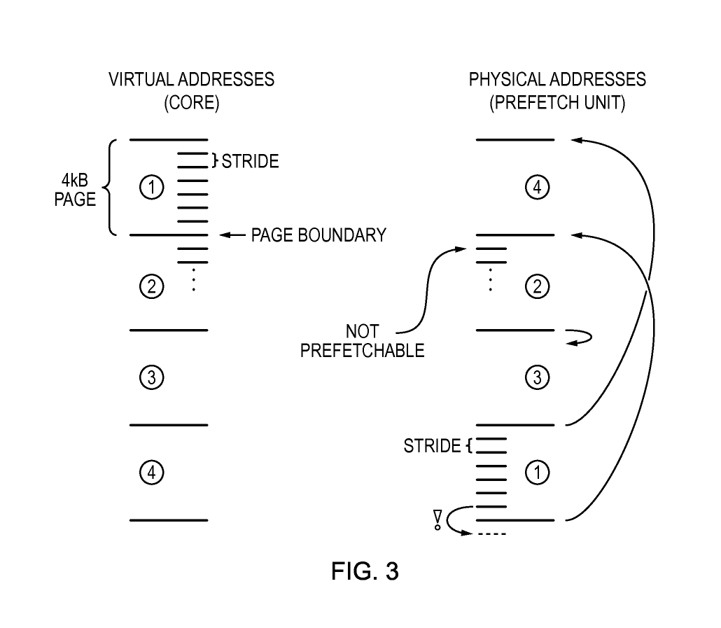

FIG. 3 schematically illustrates memory usage in the data processing apparatus and in particular the correspondence between the virtual addresses used by the processor cores 11, 12 and the physical addresses used higher in the memory hierarchy, in particular in the L2 cache 17 and therefore the prefetch unit 19. Memory addresses in the data processing apparatus 10 are handled on a paged basis, where 4 kB pages of memory addresses are handled as a unit. Whilst the memory addresses within a 4 kB page of memory addresses that are sequential in the virtual addressing system will also be sequential in the physical addressing, there is no correlation between the ordering of the memory pages in the virtual address system and the ordering of the memory pages in the physical address system. This fact is of particular significance to the prefetch unit 19, since although the stride which indicates the increment at which it prefetches addresses for a given entry in the prefetch table 21 will typically be well within the size of a memory page (meaning that the prefetch unit 19 can sequentially issue prefetch transactions at the stride interval for physical addresses), once a page boundary is reached the next increment of a prefetch transaction for this entry in the prefetch table 21 cannot be guaranteed to simply be a stride increment of the last physical address used. For example, as shown in FIG. 3 physical address page 2 does not sequentially follow physical address page 1. Accordingly, it can been seen that the first physical memory address within page 2 is not prefetchable since this physical address cannot be predicted by the prefetch unit 19 on the basis of the last physical address used in physical address page 1.

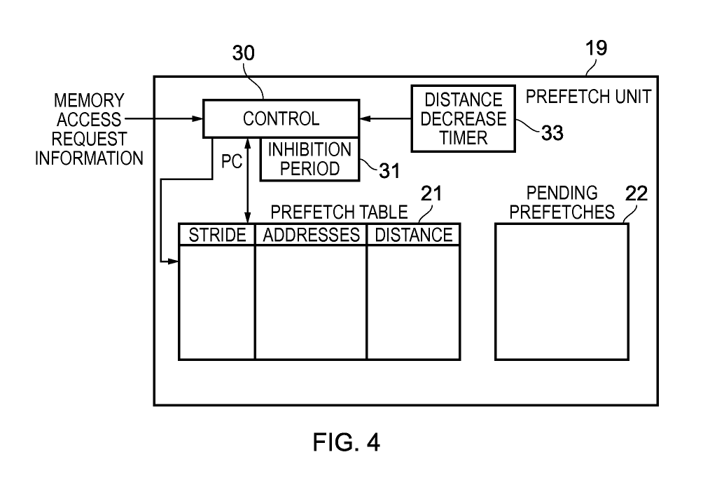

FIG. 4 schematically illustrates more detail of the prefetch unit 19. Prefetch unit 19 operates under the general control of the control unit 30, which receives information indicative of the memory access requests which are seen by L2 cache 17. The control unit 30 is in particular configured to determine circumstances (also referred to herein as an inhibition condition) under which the normal response of increasing the prefetch distance when a memory access request hits in a line 20 in the L2 cache 17 which is still the process of being prefetched (as indicated by the content of pending prefetches list 22) is suppressed for an inhibition period. In other words, the usual response of increasing the prefetch distance will not happen unless the memory access request hits in the line that is in the process of being prefetched more than a time given by the inhibition period after the inhibition condition was been detected. The inhibition period is a configurable parameter of the prefetch unit 19 which the control unit 30 can determine from the stored inhibition period value 31. This inhibition period can be varied depending on the particular system configuration, but can for example be arranged to correspond to a multiple of the memory access latency (for example be set to ˜400 cycles, where the memory latency is ˜200 cycles). Furthermore, whilst the control unit administers the maintenance of the content of the prefetch table 21, for example updating an entry when required, this updating can also be suppressed in response to the inhibition condition. In addition the prefetch unit 19 is configured to suppress the above mentioned “stride check” when it is determined that a page boundary has been crossed, since the discontinuity in the physical addresses which is likely associated with crossing a page boundary means that the stride check will corresponding likely fail (through no fault of the current set up of the prefetch table).

One circumstance under which the control unit 30 determines the inhibition condition to be met is the crossing of a page boundary (as discussed above with reference to FIG. 3). The prefetch unit 19 forms part of the memory system of the data processing apparatus 10 and is therefore aware of the page sizes being used and thus when a page boundary is crossed. Another circumstance under which the control unit 30 is configured to determine that the inhibition condition is met is when the prefetch distance for a given entry in the prefetch table 21 has in fact just recently been increased (where recently here means less than the inhibition period 31 ago). A further feature of the control unit 30 is that in administering the entries in the prefetch table 21, it is configured to periodically (in dependence on a signal received from the distance decrease timer 33) to decrease the prefetch distance associated with entries in the prefetch table 21. This provides a counterbalance to the above described behaviours which may result in the prefetch distance being increased. Accordingly, the control unit 30 is thus configured to periodically reduce the prefetch distance associated with a given entry in the prefetch table 21, whilst then increasing this prefetch distance as required by the prefetching performance of the prefetch unit 19 with respect to that entry.

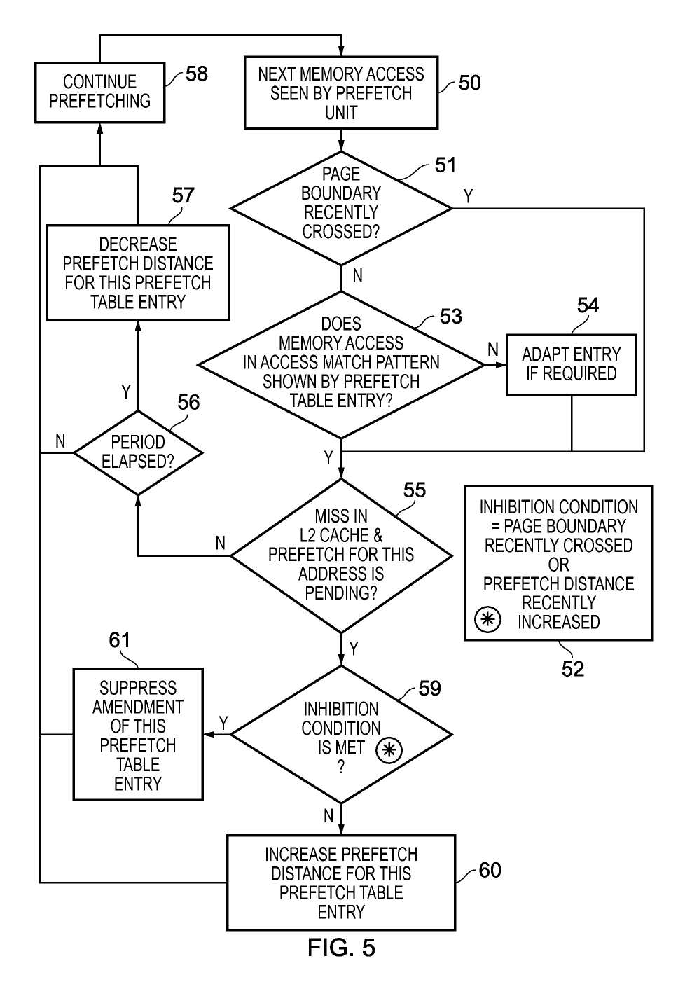

FIG. 5 schematically illustrates a sequence of steps that may be taken by a prefetch unit in one embodiment. The flow can be considered to commence at step 50 where the prefetch unit observes the next memory access request received by the L2 cache. Then at step 51 it is determined by the prefetch unit if the inhibition condition is currently met. At this stage of this embodiment, this being that a page boundary has recently been crossed. If it is determined at step 51 that the inhibition condition is not met (i.e. if a page boundary has not recently been crossed) than the prefetch unit 19 behaves in accordance with its general configuration and at step 53 it is determined if the memory address in the memory access request received by the L2 cache matches the pattern shown by the corresponding entry in the prefetch entry 21 (i.e. the stride check is performed). If it does correctly match, then the information held in this entry of the prefetch table 21 continues to correctly predict memory addresses. If however variation is observed then the flow proceeds to step 54 where the entry in the prefetch table 21 is adapted if required in accordance with the usual prefetch table administration policy. It is then (possibly directly from step 51 if a page boundary has recently been crossed) determined at step 55 if this latest memory access request received by the L2 cache has resulted in a miss and if (with reference to the list of pending prefetches 22) a prefetch for this memory address is currently pending. If this is not the case then the flow proceeds to step 56 where it is determined if the period of the distance decrease timer 33 has elapsed. If it has not then the flow proceeds directly to step 58 where the prefetch unit 19 continues performing its prefetching operations and thereafter the flow returns to step 50. If however it is determined at step 56 that the period of the distance decrease timer 33 has elapsed then at step 57 the prefetch distance for this prefetch table entry is decreased and the flow then continues via step 58.

Returning to a consideration of step 55, if it is found to be true that the memory access request has resulted in a miss in the L2 cache and a prefetch transaction for the corresponding memory address is currently pending, then the flow proceeds to step 59 where the control unit 30 of the prefetch unit 19 determines if the inhibition condition is currently met (note that at this stage of this embodiment, as defined in box 52 of FIG. 5, this being that a page boundary has recently been crossed or that the prefetch distance for an entry in the prefetch table corresponding to the memory access request seen at step 50 has recently been increased). Note that “recently” here refers to within the inhibition period 31 currently defined for the operation of the prefetch unit 19. If the inhibition condition is not met then the flow proceeds to step 60 where the control unit 30 causes the prefetch distance for this entry in the prefetch table 21 to be increased and thereafter the flow continues via step 58. If however it is determined at step 59 that the inhibition condition is not currently met then the flow proceeds via step 61 where the control unit 30 supresses amendment of this prefetch table entry (including not increasing the prefetch distance). The flow then also continues via step 58.

Although a particular embodiment has been described herein, it will be appreciated that the invention is not limited thereto and that many modifications and additions thereto may be made within the scope of the invention. For example, various combinations of the features of the following dependent claims could be made with the features of the independent claims without departing from the scope of the present invention.

We claim:

1. A data processing apparatus comprising:
an instruction execution unit configured to execute a sequence of program instructions, wherein execution of at least some of the program instructions initiate memory access requests to retrieve data values from a memory;
a cache unit configured to store copies of the data values retrieved from the memory; and
a prefetch unit configured to prefetch the data values from the memory for storage in the cache unit before they are requested by the instruction execution unit by extrapolating a current data value access pattern of the memory access requests to predict future data values which will be requested by the instruction execution unit and prefetching the future data values,
wherein the prefetch unit is configured to perform a miss response comprising increasing a number of the future data values which it prefetches when a memory access request specifies a pending data value which is already subject to prefetching but is not yet stored in the cache unit,
wherein the prefetch unit is configured, in response to an inhibition condition being met, to temporarily inhibit the miss response for an inhibition period.

2. The data processing apparatus as claimed in claim 1, wherein the inhibition condition comprises identification of a mandatory miss condition, wherein the mandatory miss condition is met when it is inevitable that the pending data value specified by the memory access request is not yet stored in the cache unit.

3. The data processing apparatus as claimed in claim 2, wherein the mandatory miss condition is met when the memory access request is not prefetchable.

4. The data processing apparatus as claimed in claim 1, wherein the prefetch unit is configured to perform a stride check for each memory access request, wherein the stride check determines if the memory access request does extrapolate the current data value access pattern, and wherein memory addresses in the data processing apparatus are administered in memory pages, and wherein the prefetch unit is configured to suppress the stride check in response to a set of memory addresses corresponding to the number of the future data values crossing a page boundary.

5. The data processing apparatus as claimed in claim 1, wherein memory addresses in the data processing apparatus are administered in memory pages and the inhibition condition is met when a set of memory addresses corresponding to the number of the future data values crosses a page boundary.

6. The data processing apparatus as claimed in claim 1, wherein the prefetch unit is configured such that the inhibition condition is met for a predetermined period after the number of the future data values has been increased.

7. The data processing apparatus as claimed in claim 1, wherein the inhibition period is a multiple of a typical memory latency of the data processing apparatus, the memory latency representing a time taken for a data value to be retrieved from the memory.

8. The data processing apparatus as claimed in claim 1, wherein the data processing apparatus comprises plural instruction execution units configured to execute the sequence of program instructions.

9. The data processing apparatus as claimed in claim 1, wherein the instruction execution unit is configured to execute multiple threads in parallel when executing the sequence of program instructions.

10. The data processing apparatus as claimed in claim 8, wherein the instruction execution unit is configured to operate in a single instruction multiple thread fashion.

11. The data processing apparatus as claimed in claim 1, wherein the prefetch unit is configured to periodically decrease the number of future data values which it prefetches.

12. The data processing apparatus as claimed in claim 1, wherein the prefetch unit is configured to administer the prefetching of the future data values with respect to a prefetch table, wherein each entry in the prefetch table is indexed by a program counter value indicative of a selected instruction in the sequence of program instructions, and each entry in the prefetch table indicates the current data value access pattern for the selected instruction, and wherein the prefetch unit is configured, in response to the inhibition condition being met, to suppress amendment of at least one entry in the prefetch table.

13. A data processing apparatus comprising:
means for executing a sequence of program instructions, wherein execution of at least some of said program instructions initiate memory access requests to retrieve data values from a memory;
means for storing copies of the data values retrieved from the memory; and
means for prefetching the data values from the memory for storage by the means for storing before they are requested by the means for executing by extrapolating a current data value access pattern of the memory access requests to predict future data values which will be requested by the means for executing and prefetching the future data values,
wherein the means for prefetching is configured to perform a miss response comprising increasing a number of the future data values which it prefetches when a memory access request specifies a pending data value which is already subject to prefetching but is not yet stored in the means for storing,
wherein the means for prefetching is configured, in response to an inhibition condition being met, to temporarily inhibit the miss response for an inhibition period.

14. A method of data processing comprising the steps of:
executing a sequence of program instructions, wherein execution of at least some of said program instructions initiate memory access requests to retrieve data values from a memory;
storing copies of the data values retrieved from the memory in a cache;
prefetching the data values from the memory for storage in the cache before they are requested by the executing step by extrapolating a current data value access pattern of the memory access requests to predict future data values which will be requested by the executing step and prefetching the future data values;
performing a miss response comprising increasing a number of the future data values which prefetched when a memory access request specifies a pending data value which is already subject to prefetching but is not yet stored in the cache; and
in response to an inhibition condition being met, temporarily inhibiting the miss response for an inhibition period.
